(19) United States
(12) Patent Application Publication
(10) Pub. No.: US 2023/0090195 A1
(43) Pub. Date: Mar. 23, 2023

(54) DISPLAY DEVICE, IMAGE PROCESSING APPARATUS, AND DISPLAY METHOD

(71) Applicant: SHARP KABUSHIKI KAISHA, Osaka (JP)

(72) Inventor: CHIKARA MATSUDA, Osaka (JP)

(21) Appl. No.: 17/942,085

(22) Filed: Sep. 9, 2022

(30) Foreign Application Priority Data
Sep. 22, 2021 (JP) 2021-154528

(51) Int. Cl. G06F 3/04845; G06F 3/04855; G06F 3/04847

(52) U.S. Cl. CPC G06F 3/04845; G06F 3/04855; G06F 3/04847; G06F 2203/04803; H04N 1/00506

(57) ABSTRACT

A display device includes a displayer capable of displaying pieces of information having different priorities for screen display in individual display areas, and a controller that generates an information display screen by controlling screen display of the display areas. The controller determines, according to an occupancy status of a display area that displays information having the highest priority on the information display screen, a display mode of a display area that displays other information having different priority.

### BACKGROUND OF THE INVENTION

### Field of the Invention

The present disclosure relates to a display device and the like.

### Description of the Background Art

In some image processing apparatuses such as multifunction machines, a plurality of items such as, for example, device information are displayed individually in a permanently installed display area.

Some pieces of information concerning device information are related to a paper feed tray. The number of installed paper feed trays varies depending on a grade of a multifunction machine, an option selection status, an actual installation status, and the like. Therefore, information on the number of paper feed trays to be displayed in a display area varies according to the number of installed trays.

In a case where an installation state of a paper feed tray is changed, if a display area serving as a maximum display area is secured in order to display information concerning paper feed trays without omission, there is a problem that a wasted area where nothing is displayed may be generated, in a case where the number of installed paper feed trays decreases.

In addition, as a display area for a paper feed tray is secured, a display area for displaying other adjacent information (e.g., information concerning a device state, and the like) may decrease, and sufficient information may not be displayed.

In order to secure a sufficient display area, for example, it is known that a size of an area is reduced, in a case where data to be displayed are not present in an area that displays a display item of a registered job on an operation screen of an image forming apparatus, and an item that is not normally displayed on the operation screen is displayed in a vacant space.

However, a conventional technique has not considered that after individually securing a display area for displaying a plurality of items, a display area that displays other device information is adjusted according to a change in a display area that displays target device information, such as, for example, information concerning a paper feed tray.

An object of the present disclosure is to provide a display device and the like that can adjust a display area that displays other device information according to a change in a display area that displays target device information, after individually securing a display area for displaying a plurality of items.

### SUMMARY OF THE INVENTION

In order to solve the above problem, a display device according to the present disclosure includes: a displayer capable of displaying pieces of information having different priorities for screen display in individual display areas; and a controller that generates an information display screen by controlling screen display of the display areas. The controller determines, according to an occupancy status of a display area that displays information having the highest priority on the information display screen, a display mode of a display area that displays other information having different priority.

Further, an image processing apparatus according to the present disclosure includes: the above-described display device; and an image processor.

Further, a display method according to the present disclosure includes: displaying pieces of information having different priorities for screen display in individual display areas; and generating an information display screen by controlling screen display of the display areas. The controlling includes determining, according to an occupancy status of a display area that displays information having the highest priority on the information display screen, a display mode of a display area that displays other information having different priority.

According to the present disclosure, it is possible to provide a display device and the like that can adjust a display area that displays other device information according to a change in a display area that displays target device information, after individually securing a display area for displaying a plurality of items.

### BRIEF DESCRIPTION OF THE DRAWINGS

FIG. 1 is an external perspective view of a multifunction machine according to a first embodiment.

FIG. 2 is a functional configuration diagram of the multifunction machine according to the first embodiment.

FIG. 3 is a diagram illustrating a priority information management table.

FIG. 4 is a diagram illustrating a display layout management table.

FIG. 5 is a flowchart illustrating a flow of processing according to the first embodiment.

FIG. 6 is a diagram illustrating an operation example according to the first embodiment.

FIG. 7 is a diagram illustrating an operation example according to the first embodiment.

FIG. 8 is a diagram illustrating an operation example according to the first embodiment.

FIG. 9 is a diagram illustrating an operation example according to the first embodiment.

FIG. 10 is a flowchart illustrating a flow of processing according to a second embodiment.

FIG. 11 is a diagram illustrating an operation example according to the second embodiment.

FIG. 12 is a flowchart illustrating a flow of processing according to a third embodiment.

FIGS. 13A and 13B are diagrams each illustrating an operation example according to the third embodiment.

FIG. 14 is a diagram illustrating an operation example according to the third embodiment.

FIG. 15 is a functional configuration diagram of a multifunction machine according to a fourth embodiment.

FIG. 16 is a flowchart illustrating a flow of processing according to the fourth embodiment.

FIG. 17 is a diagram illustrating an operation example according to the fourth embodiment.

FIGS. 18A and 18B are diagrams each illustrating an operation example according to the fourth embodiment.

FIG. 19 is a diagram illustrating an operation example according to the fourth embodiment.

### DESCRIPTION OF THE PREFERRED EMBODIMENTS

In the following, embodiments according to the present disclosure are described with reference to the drawings. In the present disclosure, description is made based on a premise that a multifunction machine capable of executing a job pertaining to, for example, copying, faxing, image transmission, or the like by means of one housing is an embodiment of a display device according to the present disclosure or an image processing apparatus incorporated with the display device. Note that, the following embodiments are an example for describing the present disclosure, and the technical scope of the description described in the claims is not limited to the following description.

### 1 First Embodiment

A first embodiment is an embodiment in which a display area that displays other information having a different priority is increased or decreased according to an occupancy status of a display area that displays information having a highest priority on an information display screen.

Note that, a priority as used in the present specification means a display priority order of device information on an information display screen. Information having a highest priority is device information in which a display priority on an information display screen is highest, and is equivalent to target device information. Note that, in the present specification, a display area that displays information having a highest priority is specifically referred to as an occupied area, and is distinguished from a display area that displays other information having a different priority.

Further, an occupancy status as used in the present specification is a concept representing a degree of occupancy of a display area with respect to an information display screen, such as a display status, a display state, or a display ratio of a display area (occupied area) that displays device information having a highest priority. In the present disclosure, a display area that occupies a part or all of an information display screen can be configured by displaying information by means of a column display in which one or more columns capable of displaying information row by row are combined, or on a graphic such as a rectangle having a predetermined display area (size), or a straight line having a predetermined length in horizontal and vertical directions. In the present specification, a degree of occupancy of an occupied area to be expressed by using a column display, a graphic, or the like with respect to an information display screen is referred to as an occupancy status.

### 1.1 Functional Configuration

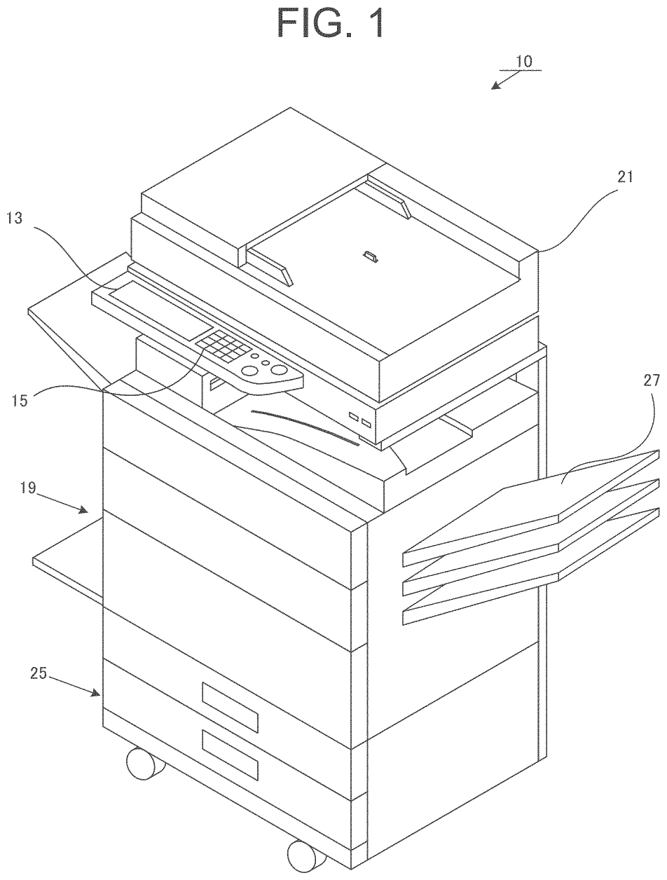

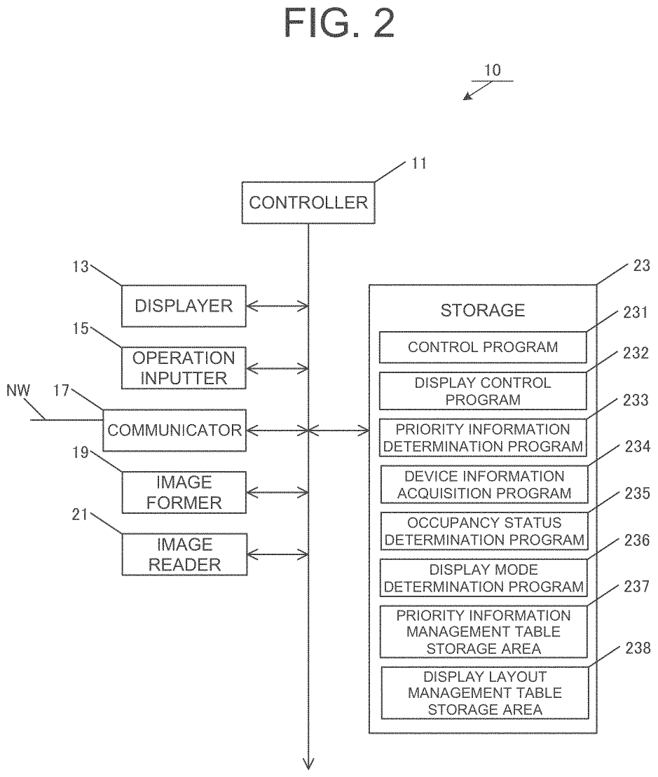

A functional configuration of a multifunction machine 10 according to a first embodiment is described with reference to FIGS. 1 and 2. FIG. 1 is an external perspective view schematically illustrating an overall configuration of the multifunction machine 10. FIG. 2 is a functional configuration diagram of the multifunction machine 10. The multifunction machine 10 includes a controller 11, a displayer 13, an operation inputter 15, a communicator 17, an image former 19 and an image reader 21 as an image processor, and a storage 23.

The controller 11 controls the entirety of the multifunction machine 10. The controller 11 is configured of, for example, one or more arithmetic devices (such as a central processing unit (CPU)). The controller 11 achieves its function by reading and executing various programs stored in the storage 23.

The displayer 13 displays various pieces of information to a user or others. The displayer 13 can be configured of, for example, a liquid crystal display (LCD), an organic electro-luminescence (EL) display, or the like.

The operation inputter 15 accepts an input of information by a user or others. The operation inputter 15 can be configured of hard keys (e.g., a numeric keypad), buttons, and the like. Note that, the operation inputter 15 can be configured as a touch panel that allows an input via the displayer 13. In this case, as an input method of a touch panel, for example, a general method such as a resistive film method, an infrared method, an electromagnetic induction method, and an electrostatic capacitance method can be employed.

The communicator 17 includes either one or both of wired and wireless interfaces for performing communication with another device via a network (NW) such as, for example, a local area network (LAN), a wide area network (WAN), the Internet, a telephone line, or a fax line.

The image former 19 forms an image based on image data on paper as a recording medium. The image former 19 feeds paper from a paper feeder 25, forms an image based on image data on the paper, and then discharges the paper to a paper discharger 27. The image former 19 can be configured of, for example, a laser printer or the like using an electrophotographic method. In this case, the image former 19 performs image formation by using toner supplied from unillustrated toner cartridges associated with toner colors (e.g., cyan (C), magenta (M), yellow (Y), and black (K)).

The image reader 21 generates image data by scanning and reading a document image to be read. The image reader 21 can be configured, for example, as a scanner device including an image sensor such as a charge coupled device (CCD), and a contact image sensor (CIS). There is no restriction on a configuration of the image reader 21, as long as the image reader 21 is configured to generate image data by reading a reflected light image from a document image with use of an image sensor.

The storage 23 stores various programs necessary for an operation of the multifunction machine 10, and various pieces of data. The storage 23 can be configured of a storage device such as, for example, a random access memory (RAM), a hard disk drive (HDD), a solid state drive (SSD), and a read only memory (ROM).

In the first embodiment, the storage 23 stores a control program 231, a display control program 232, a priority information determination program 233, device information acquisition program 234, an occupancy status determination program 235, and a display mode determination program 236, and secures a priority information management table storage area 237 and a display layout management table storage area 238.

The control program 231 is a program to be read by the controller 11 for performing processing based on each function, such as copying, faxing, and image transmission. After reading the control program 231, the controller 11 executes a job based on copying, faxing, image transmission functions, and the like by controlling the displayer 13, the operation inputter 15, the communicator 17, the image former 19, the image reader 21, and the like.

The display control program 232 is a program to be read by the controller 11 when controlling the displayer 13 and the operation inputter 15. After reading the display control program 232, the controller 11 controls screen display on the displayer 13. After reading the display control program 232, the controller 11 controls to output, for example, a home screen, an information display screen, and the like to be described later. Note that, the present disclosure is described based on a premise that the controller 11 controls input and output of a touch panel, which is an example of the operation inputter 15, but it is also possible to configure the displayer 13 and the operation inputter 15 as separate components.

The priority information determination program 233 is a program to be read by the controller 11 when determining a priority set for information to be displayed in individual display areas. After reading the priority information determination program 233, the controller 11 determines a priority set for individual pieces of device information by referring to the priority information management table to be described later. In the first embodiment, information concerning a paper feed tray (hereinafter, also referred to as “paper feed tray information”) is described as an example of device information having a highest priority for screen display. The number of installed paper feed trays varies depending on a grade of a multifunction machine, an option selection status, an actual installation status, and the like. Specifically, paper feed tray information is device information in which the number of display items (information amount) in a display area is likely to increase or decrease. As the number of display items is increased or decreased, an occupancy status of a display area (occupied area) that displays paper feed tray information is changed. In the first embodiment, an example is described in which paper feed tray information is target device information having a highest priority, and a display area that displays other device information having a different priority is increased or decreased according to an increase or a decrease (occupancy status) of an occupied area that displays the paper feed tray information.

The device information acquisition program 234 is a program to be read by the controller 11 when acquiring device information to be displayed in individual display areas. After reading the device information acquisition program 234, the controller 11 acquires, as paper feed tray information, device state information concerning a device state such as a communication state, device setting information concerning device settings such as language settings, notice information concerning a notice to a user, and the like, in addition to the number of installed paper feed trays, and information (such as a paper type, a paper size, and an approximate number of remaining sheets) concerning paper to be accommodated in the paper feed tray.

The occupancy status determination program 235 is a program to be read by the controller 11 when determining an occupancy status of an occupied area that displays information having a highest priority in acquired device information. After reading the occupancy status determination program 235, the controller 11 determines, based on the acquired device information, an occupancy status such as a display status (e.g., the number of rows for a column display, a display area, and the like) of an occupied area on an information display screen, a display state (e.g., a display layout on an information display screen (such as a display position, a positional relationship with respect to a display area that displays other information having a different priority)), and a display ratio of an occupied area on an information display screen.

The display mode determination program 236 is a program to be read by the controller 11 when determining a display mode of other information having a different priority, based on a determination result on an occupancy status of an occupied area. In the first embodiment, after reading the display mode determination program 236, the controller 11 determines a display mode of a display area of other information having a different priority by comparing an occupied area acquired by determination on an occupancy status with a predetermined threshold value. For example, in a case where the controller 11 determines that the occupied area is larger than the predetermined threshold value, the controller 11 performs processing of decreasing (making small) a display area of other information having a different priority. On the other hand, in a case where the controller 11 determines that the occupied area is smaller than the predetermined threshold value, the controller 11 performs processing of increasing (making large) a display area of other information having a different priority.

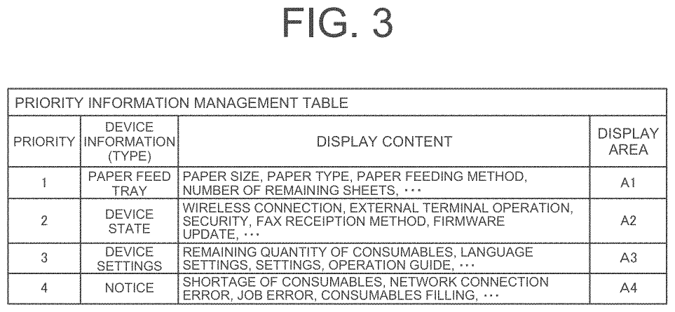

The priority information management table storage area 237 is a storage area that stores a priority information management table that manages a priority set for device information. Herein, an example of a data configuration of the priority information management table is described using FIG. 3.

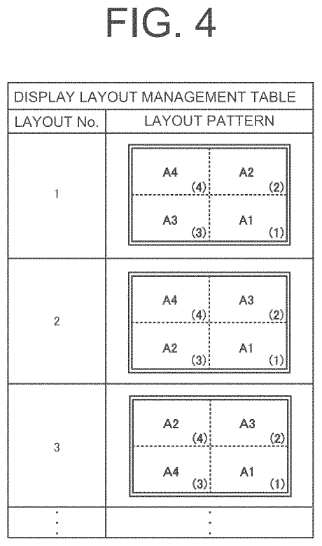

FIG. 3 is a diagram illustrating an example of a data configuration of the priority information management table according to the first embodiment. As illustrated in FIG. 3, in the priority information management table, device information (type) is associated with a priority according to which screen display is prioritized. In FIG. 3, priority “1” (highest display priority) is associated with “paper feed tray” as device information (type). Herein, display content represents a content of device information to be displayed on an information display screen. For example, in a display area pertaining to a paper feed tray, paper feed tray information such as “paper size”, “paper type”, “paper feeding method”, and “number of remaining sheets” are displayed as display content. The display area represents a display area of device information on an information display screen. The display area in the information display screen is described in FIG. 4.

Referring back to FIG. 2, the display layout management table storage area 238 is a storage area that stores a display layout management table that manages a display layout on an information display screen. Herein, an example of a data configuration of the display layout management table is described using FIG. 4.

The display layout management table is a storage area that stores a layout number and a layout pattern in association with each other. The layout number is an identification number for identifying a layout pattern. The layout pattern divides a displayable area capable of displaying an information display screen into a lower right area (1), an upper right area (2), a lower left area (3), and an upper left area (4), and specifies a display location of a display area by allocating a display area that displays device information to these four areas. For example, a layout pattern of layout No. 1 is a pattern in which an occupied area (A1) that displays paper feed tray information is allocated to the lower right area (1), an occupied area (A2) that displays device state information is allocated to the upper right area (2), a display area (A3) that displays device setting information is allocated to the lower left area (3), and a display area (A4) that displays notice information is allocated to the upper left area (4). Note that, cross-shaped dotted lines that divide the displayable area into areas in up and down, and left and right directions are indicated in an image diagram representing the information display screen in FIG. 4. This is for the purpose of intuitively recognizing a display position in a display area, and a size and a shape of a display area that displays device information is not limited to this notation.

### 1.2 Flow of Processing

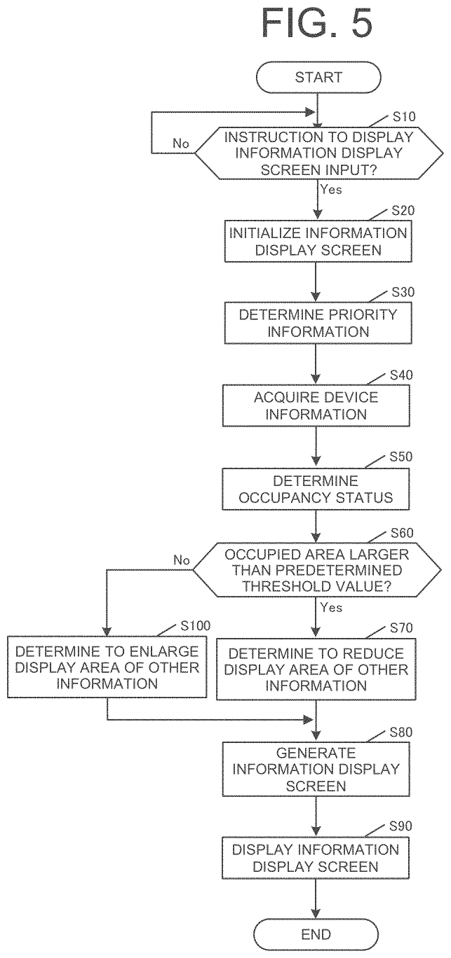

Next, a flow of processing according to the first embodiment is described using the flowchart in FIG. 5. The present processing is processing to be performed by causing the controller 11 to read and execute the control program 231, the display control program 232, the priority information determination program 233, the device information acquisition program 234, the occupancy status determination program 235, the display mode determination program 236, and the like.

First, the controller 11 determines whether an instruction to display an information display screen has been input (step S10). The user may input an instruction to display an information display screen by pressing an input button provided, for example, on a home screen or the like.

When an instruction to display an information display screen is input, the controller 11 initializes the information display screen (step S10; Yes→step S20). In a case where an instruction to display an information display screen display is not input, the controller 11 continues to display the home screen or the like (step S10; No).

Next, the controller 11 determines a priority set for information to be displayed in individual display areas by reading the priority information determination program 233 (step S30). The controller 11 determines device information having a highest priority, and determines device information other than the determined device information, as other device information having a different priority by referring to the priority information management table illustrated in FIG. 3.

Then, the controller 11 acquires device information for displaying in individual display areas by reading the device information acquisition program 234 (step S40).

The controller 11 determines an occupancy status of an occupied area that displays information having a highest priority in the acquired device information by reading the occupancy status determination program 235 (step S50).

The controller 11 determines a display mode of a display area of other information having a different priority by comparing the occupied area with a predetermined threshold value, based on a determination result on an occupancy status of an occupied area in step S50 (step S60). In a case where the controller 11 determines that the occupied area is larger than the predetermined threshold value, the controller 11 determines to reduce the display area that displays other information having a different priority (step S60; Yes→step S70). Subsequently, the controller 11 generates an information display screen, based on the determination result in step S70 (step S80), and terminates the processing by displaying the generated information display screen on the displayer 13 (step S90).

On the other hand, in a case where the controller 11 determines that the occupied area is smaller than the predetermined threshold value, the controller 11 determines to enlarge the display area that displays other information having a different priority (step S60; No→step S100). Then, the controller 11 generates an information display screen, based on the determination result in step S100 (step S80), and terminates the processing by displaying the generated information display screen on the displayer 13 (step S90).

### 1.3 Operation Example

Next, an operation example according to the first embodiment is described. Note that, in the present operation example, an example is described in which a display area that displays device information such as paper feed tray information is a column display. Also, description is made based on a premise that, as a predetermined threshold value for an occupied area, the column row number is two. However, the column row number as a threshold value is merely an example, and the predetermined threshold value can be changed as necessary. Further, in the present operation example, description is made based on a premise that a display layout of a display area to be displayed by the controller 11 follows the display layout of layout No. 1 illustrated in FIG. 4.

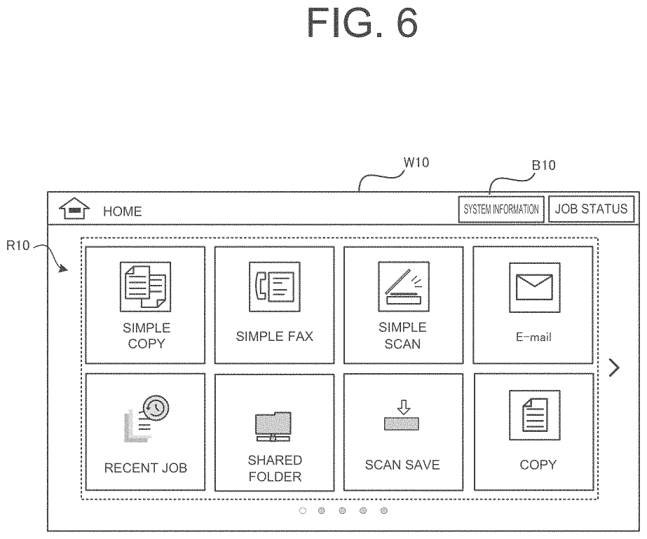

FIG. 6 is a diagram illustrating a configuration example configuration of a home screen W10 that accepts an input of an instruction to display a system information screen as an information display screen. The home screen W10 is a basic screen to be displayed on the displayer 13 by the controller 11 when the power of the apparatus is turned on, when the apparatus is restored from a sleep mode, after a login user logs in, and the like.

The home screen W10 includes a device function selection button area R10, and a system information display button B10. The device function selection button area R10 includes input buttons in which settings and various pieces of information concerning device functions such as image input/output, communication, job relations, or maintenance are graphically represented by means of graphics, letters/numbers, symbols, or the like. In the example illustrated in FIG. 6, the device function selection button area R10 includes a simple copy button, a simple fax button, a simple scan button, an e-mail button, a recent job button, a shared folder button, a scan save button, and a copy button. The user can execute a function based on the target function by selecting and pressing a desired input button from among these input buttons.

The system information display button B10 is an input button that accepts an input of an instruction to display a system information screen as an information display screen to be described with reference to the following drawing. In response to a display instruction input by user pressing of the button, the controller 11 displays the system information screen on the displayer 13.

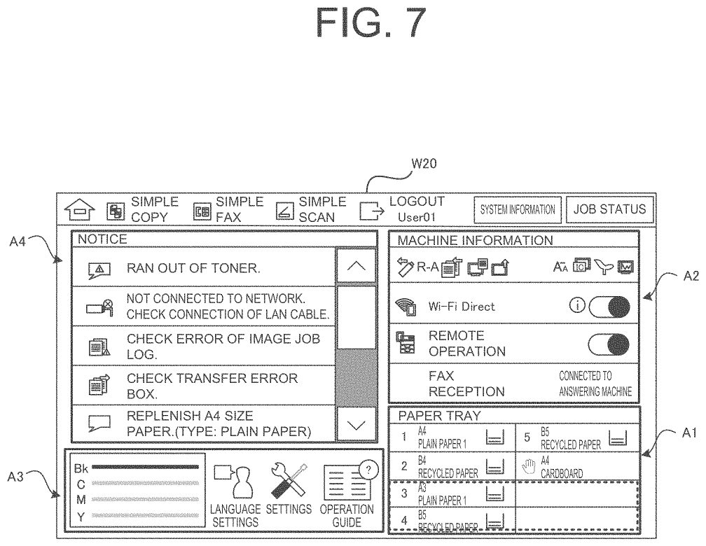

FIG. 7 is a diagram illustrating a configuration example of a system information display screen W20 to be displayed on the displayer 13 by the controller 11 in response to a display instruction input by user pressing of the system information display button B10.

On the system information display screen W20, the occupied area (A1) that displays paper feed tray information is allocated to the lower right area (1), the display area (A2) that displays device state information (machine information) is allocated to the upper right area (2), the display area (A3) that displays device setting information is allocated to the lower left area (3), and the display area (A4) that displays notice information is allocated to the upper left area (4) according to a display layout of layout No. 1 illustrated in FIG. 4. Note that, as illustrated in FIG. 7, a header portion (e.g., “paper feed tray”, “machine information”, and the like) for identifying device information may be provided for each display area.

Herein, the threshold value of the occupied area (A1) in the lower right area (1) is the column row number “2” indicated by the dotted line frame in FIG. 7. However, in a case where paper feed tray information is information in which the required column row number is “4”, as a result of determination on an occupancy status, the controller 11 determines that the occupied area (A1) is larger than the predetermined threshold value, and enlarges the occupied area (A1) in such a way that the column row number of the occupied area (A1) is changed from the column row number “2” to the column row number “4”.

As the column row number of the occupied area (A1) increases, the controller 11 determines to reduce the display area (A2) for displaying device state information located adjacent in the vertical direction. The controller 11 decreases the column row number secured for the display area (A2) for displaying device state information from the column row number “5” to the column row number “3”.

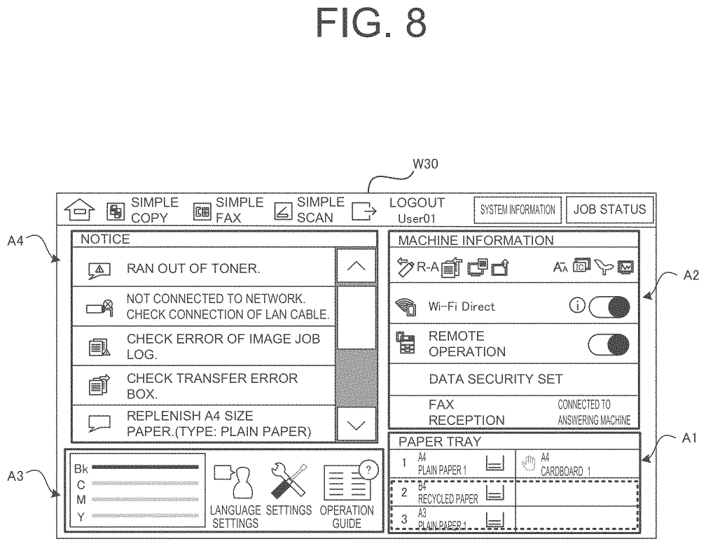

FIG. 8 is a diagram illustrating a configuration example of a system information display screen W30 in a case where paper feed tray information is information in which the required column row number is “3”, as a result of determination on an occupancy status.

In a case where, as a result of determination on an occupancy status, paper feed tray information is information in which the required column row number is “3”, the controller 11 determines that the occupied area (A1) is larger than the predetermined threshold value, and increases the column row number of the occupied area (A1) from the column row number “2” to the column row number “3”.

As the column row number of the occupied area (A1) increases, the controller 11 determines to reduce the display area (A2) for displaying device state information located adjacent in the vertical direction. The controller 11 decreases the column row number secured for the display area (A2) that displays a device state information from the column row number “5” to the column row number “4”.

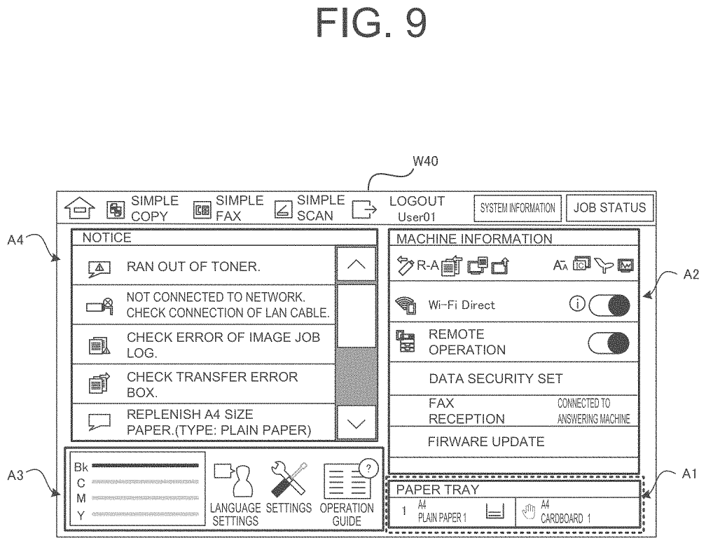

FIG. 9 is a diagram illustrating a configuration example of a system information display screen W40 in a case where paper feed tray information is information in which the required column row number is “1”, as a result of determination on an occupancy status.

In a case where, as a result of determination on an occupancy status, paper feed tray information is information in which the required column row number is “1”, the controller 11 determines that the occupied area (A1) is smaller than the predetermined threshold value, and decreases the column row number of the occupied area (A1) from the column row number “2” to the column row number “1”.

As the column row number of the occupied area (A1) decreases, the controller 11 determines to enlarge the display area (A2) for displaying device state information located adjacent in the vertical direction. The controller 11 increases the column row number secured for the display area (A2) for displaying a device state information from the column row number “5” to the column row number “6”.

Note that, in a case where the amount of information to be displayed in the display area (A2) is sufficient, for example, as illustrated in FIG. 9, vacancy is generated in a column, as the column row number of the display area (A2) increases, the column row number of the display area (A2) may not be increased. In this case, the controller 11 is able to keep the column row number “5” secured for displaying device state information unchanged.

Note that, determination on the column row number of the display area (A2) may be such that, for example, the total column row number for the occupied area (A1) and the display area (A2) is set in advance as a displayable area, and the column row number acquired by subtracting the column row number for the occupied area (A1) from the total column row number as the displayable area may be allocated to the display area (A2).

By the way, the first embodiment has been described by an example in which the display area (A2) provided in the vertical direction of the occupied area (A1) is a display area that is increased or decreased according to an occupancy status of the occupied area (A1). However, for example, it is also possible to set the display area (A3) that displays device setting information provided in the horizontal direction of the occupied area (A1), as a display area that is increased or decreased according to an occupancy status of the occupied area (A1).

As described above, according to the first embodiment, since a display area that displays other information having a different priority is expanded or reduced according to an occupancy status of an occupied area that displays information having a highest priority on an information display screen, other display area can be adjusted according to a change in a target display area, after individually securing a display area for displaying a plurality of items.

### 2 Second Embodiment

A second embodiment is an embodiment in which a display layout of a display area that displays other information having a different priority is changed according to an occupancy status of an occupied area that displays information having a highest priority on an information display screen.

### 2.1 Functional Configuration

Since a functional configuration of a multifunction machine according to the second embodiment can be made the same as that of the multifunction machine 10 according to the first embodiment, description thereof is omitted herein.

### 2.2 Flow of Processing

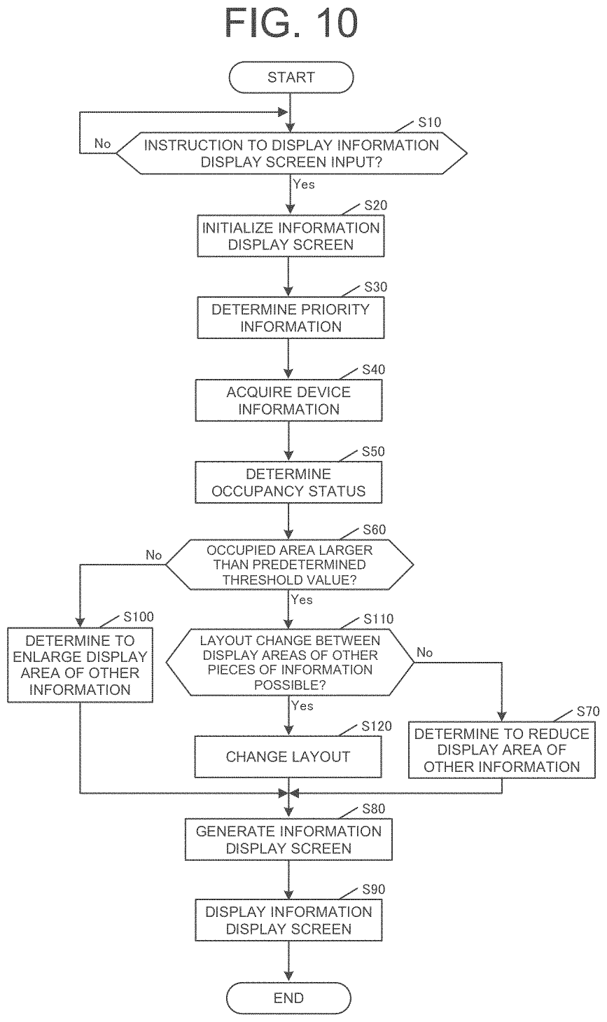

A flow of processing according to the second embodiment is described using the flowchart in FIG. 10. The present processing is processing to be performed by causing a controller 11 to read and execute a control program 231, a display control program 232, a priority information determination program 233, a device information acquisition program 234, an occupancy status determination program 235, a display mode determination program 236, and the like. Note that, the same processing as the processing illustrated in FIG. 5 of the first embodiment is indicated with the same step number.

First, the controller 11 determines whether an instruction to display an information display screen has been input (step S10). The instruction to display an information display screen can be made via pressing of an input button that accepts an input of an instruction to display an information display screen, which is provided, for example, on a home screen or the like.

When an instruction to display an information display screen is input, the controller 11 initializes the information display screen (step S10; Yes→step S20). In a case where an instruction to display an information display screen has not been input, the controller 11 continues to display the home screen, or the like (step S10; No).

Next, the controller 11 determines a priority set for the information to be displayed in individual display areas by reading the priority information determination program 233 (step S30). The controller 11 determines device information having a highest priority, and determines device information other than the determined device information, as other device information having a different priority by referring to the priority information management table illustrated in FIG. 3.

Then, the controller 11 acquires device information for displaying in individual display areas by reading the device information acquisition program 234 (step S40).

The controller 11 determines an occupancy status of an occupied area that displays information having a highest priority in the acquired device information by reading the occupancy status determination program 235 (step S50).

The controller 11 determines a display mode of a display area of other information having a different priority by comparing the occupied area with a predetermined threshold value, based on a result of determination on the occupancy status of the occupied area in step S50 (step S60). In a case where the controller 11 determines that the occupied area is larger than the predetermined threshold value, the controller 11 determines whether a layout change is possible between display areas of other information (step S60; Yes→step S110).

In a case where it is determined that a display layout change is possible between display areas of other information, the controller 11 changes the display layout (step S110; Yes→step S120).

Then, the controller 11 generates an information display screen, based on the changed display layout in step S120 (step S80), and terminates the processing by displaying the generated information display screen on a displayer 13 (step S90).

On the other hand, in a case where the controller 11 determines that the occupied area is smaller than the predetermined threshold value, the controller 11 determines to enlarge the display area that displays other information having a different priority (step S60; No→step S100). Then, the controller 11 generates an information display screen, based on the determination result in step S100 (step S80), and terminates the processing by displaying the generated information display screen on the displayer 13 (step S90).

In a case where the controller 11 determines that a display layout change is not possible between display areas of other information, the controller 11 determines to reduce the display area that displays other information having a different priority (step S110; No→step S70). Then, the controller 11 generates an information display screen, based on the determination result in step S70 (step S80), and terminates the processing by displaying the generated information display screen on the displayer 13 (step S90).

### 2.3 Operation Example

Next, an operation example according to the second embodiment is described. In the present operation example, a layout change is possible between display areas of other information, and description is made based on a premise that, as an operation equivalent to the processing in step S120 in FIG. 10, the display layout of layout No. 1 illustrated in FIG. 4 is changed to the display layout of layout No. 2.

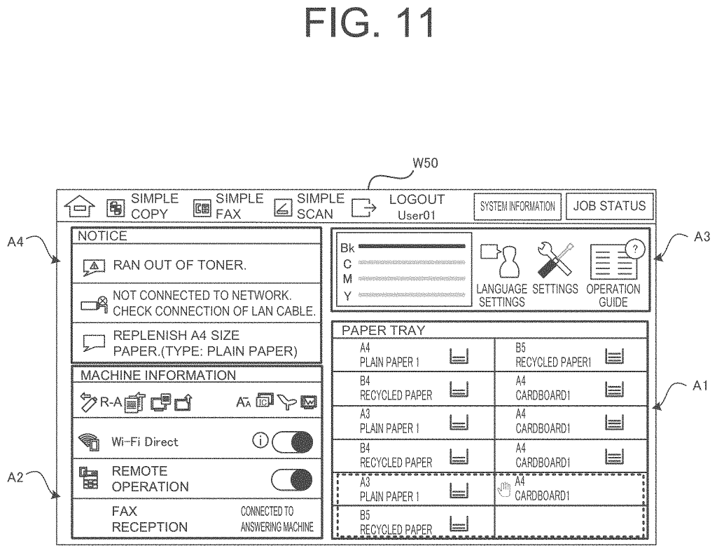

FIG. 11 is a diagram illustrating a configuration example of a system information display screen W50 in which a display layout is changed in the second embodiment.

In the system information display screen W50, an occupied area (A1) that displays paper feed tray information is allocated to a lower right area (1). Herein, a threshold value of the occupied area (A1) for displaying paper feed tray information in the lower right area (1) is the column row number “2” indicated by the dotted line frame in FIG. 11. However, in a case where paper feed tray information is information in which the required column row number is “6”, based on a determination result on an occupancy status of an occupied area, the controller 11 determines that the occupied area (A1) for displaying paper feed tray information is larger than the predetermined threshold value, and enlarges the occupied area (A1) in such a way that the column row number of the occupied area (A1) is changed from the column row number “2” to the column row number “6”.

As the column row number of the occupied area (A1) increases, a display area (A2) for displaying device state information located adjacent in the vertical direction is greatly reduced from the secured column row number “5”. Therefore, in a case where a display layout change is possible between the display area (A2) for displaying device state information and other display area, the controller 11 performs a layout change.

FIG. 11 illustrates an example of the system information display screen W50 in which the display area (A2), and a display area (A3) that displays device setting information whose amount of information to be displayed is relatively small are switched. Note that, the display layout illustrated herein is equivalent to layout No. 2 illustrated in FIG. 4.

As described above, according to the second embodiment, since a display layout of a display area that displays other information having a different priority is changed according to an occupancy status of a display area that displays information having a highest priority on an information display screen, even when an information amount of the information having the highest priority is large, and the display area that displays the information greatly occupies the screen, other display area can be adjusted according to a change in a target display area, after individually securing a display area for displaying a plurality of items.

### 3 Third Embodiment

A third embodiment is an embodiment in which, in a case where a display area that displays other information having a different priority is reduced according to an occupancy status of a display area that displays information having a highest priority on an information display screen, an input button through which an instruction to enlarge/reduce display content to be displayed in the display area is input, and a scroll bar through which an instruction to switch display content is input are displayed.

### 3.1 Functional Configuration

Since a functional configuration of the third embodiment can be made the same as that of the multifunction machine 10 according to the first embodiment, description thereof is omitted herein.

### 3.2 Flow of Processing

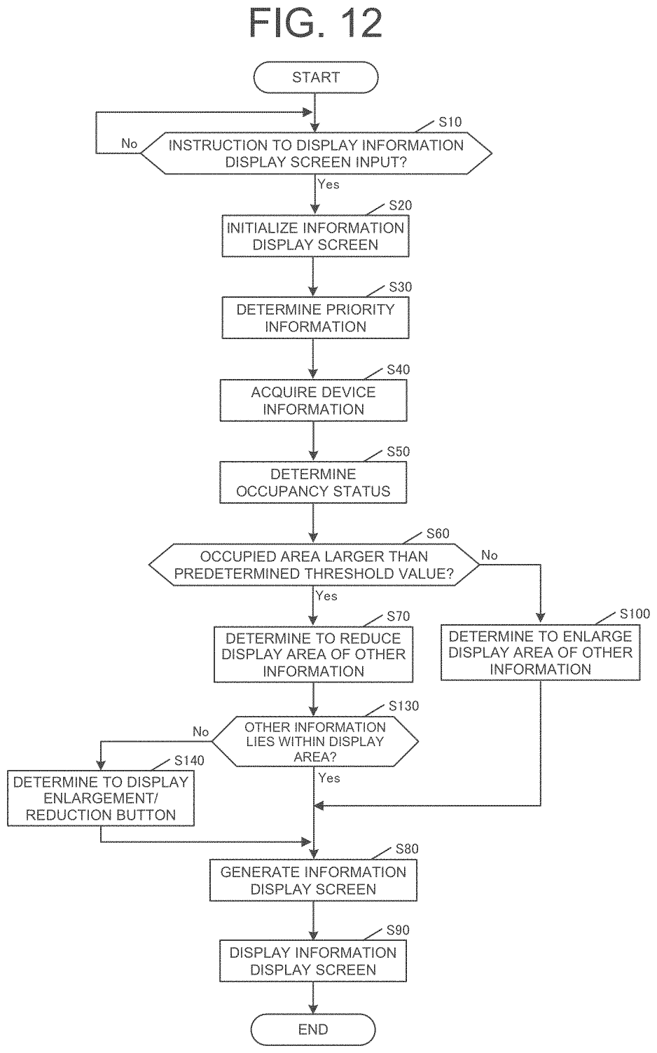

Next, a flow of processing according to the third embodiment is described using the flowchart in FIG. 12. The present processing is processing to be performed by causing a controller 11 to read and execute a control program 231, a display control program 232, a priority information determination program 233, a device information acquisition program 234, an occupancy status determination program 235, a display mode determination program 236, and the like. Note that, since a flow of processing according to the third embodiment can be made the same as the processing in steps S10 to S50 illustrated in FIG. 5 of the first embodiment, description thereof is omitted herein. Further, the same processing as the processing illustrated in FIG. 5 is indicated with the same step number.

In a case where the controller 11 determines that an occupied area is larger than a predetermined threshold value, as a result of comparison between the occupied area and the predetermined threshold value that is set in advance, the controller 11 determines to reduce a display area that displays other information having a different priority (step S60; Yes→step S70).

Subsequently, the controller 11 determines whether all pieces of other information lie within the reduced display area (step S130). In a case where it is determined that all pieces of other information lie within the reduced display area, the controller 11 generates an information display screen (step S130; Yes→step S80), and terminates the processing by displaying the generated information display screen on a displayer 13 (step S90).

On the other hand, in a case where it is determined that all pieces of other information do not lie within the reduced display area, the controller 11 determines to display an enlargement/reduction button (step S130; No→step S140). Subsequently, the controller 11 generates an information display screen (step S80), and terminates the processing by displaying the generated information display screen on the displayer 13 (step S90).

By the way, in a case where the controller 11 determines that an occupied area is smaller than a predetermined threshold value, as a result of comparison between the occupied area and the predetermined threshold value, the controller 11 determines to enlarge a display area that displays other information having a different priority (step S60; No→step S100). Then, the controller 11 generates an information display screen, based on the determination result in step S100 (step S80), and terminates the processing by displaying the generated information display screen on the displayer 13 (Step S90).

### 3.3 Operation Example

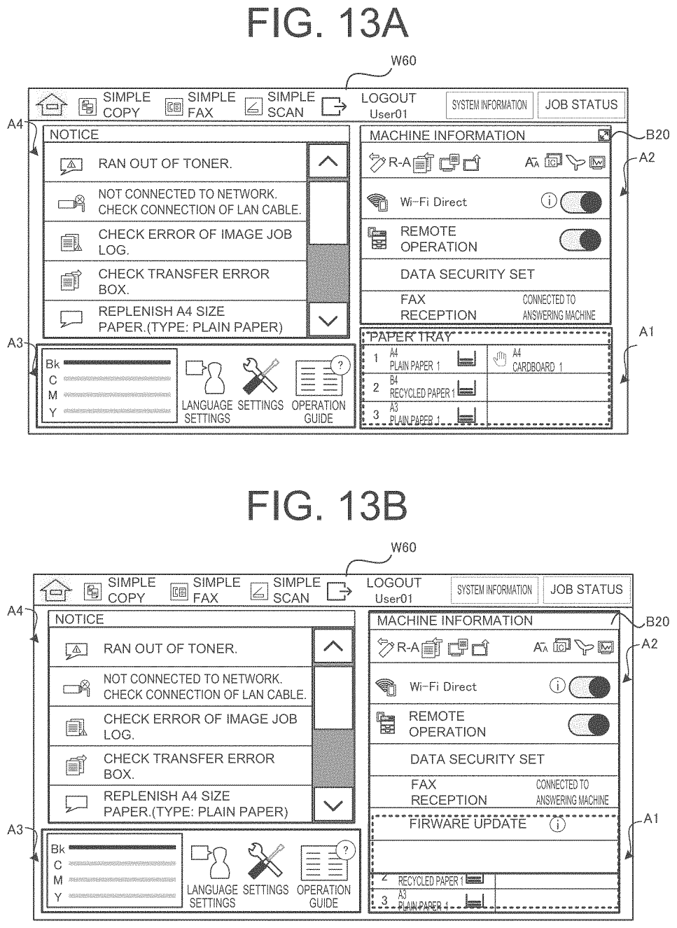

FIG. 13A is a diagram illustrating a configuration example of a system information display screen W60 to be displayed in a case where the controller 11 determines that all pieces of other information do not lie within the reduced display area in the processing in step S130 in FIG. 12. The system information display screen W60 includes an input button B20 that accepts an input of an instruction to enlarge/reduce display content in a display area (A2).

The input button B20 is provided at an upper end of the display area (A2), and accepts an input of an instruction for enlargement/reduction by user pressing.

FIG. 13B is a diagram illustrating a configuration example of the system information display screen W60 to be displayed by the controller 11 in response to an input of an enlargement instruction by pressing of the input button B20.

In response to an input of an enlargement instruction, the controller 11 enlarges and displays the display area (A2). By enlarging and displaying the display area (A2) on the occupied area (A1) indicated by the dotted line frame in FIG. 13A in a superimposed manner, information concerning “firmware update”, which is an invisible display content in FIG. 13A, is made visually recognizable.

Note that, in a case where a displayed content is not visible only by enlargement processing accompanied by pressing of the input button B20, it is also possible to further provide a scroll bar that switches a displayed content.

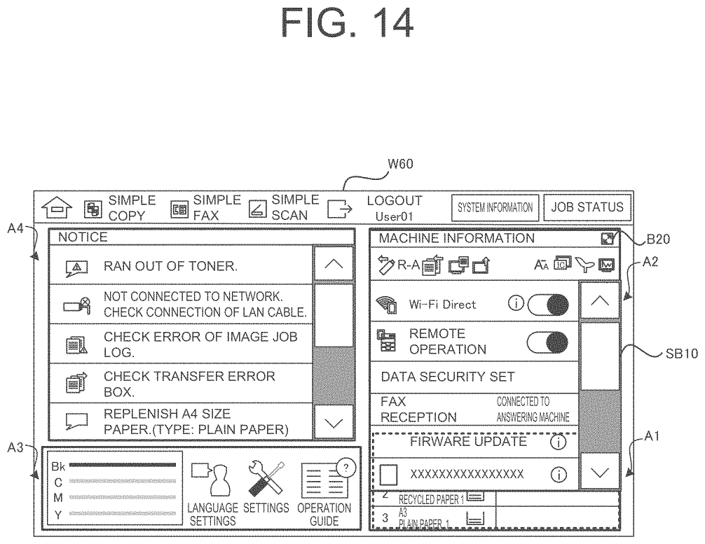

FIG. 14 is a diagram illustrating an example in which a scroll bar SB10 that accepts an input of an instruction to switch display content in the enlargedly displayed display area (A2) is provided on the system information display screen W60 illustrated in FIG. 13B.

For example, the scroll bar SB10 is provided at a right end of the display area (A2) to be operable, thereby enabling to switch display content of the display area (A2), as the bar itself is moved up and down. In the example in FIG. 14, information concerning “XXXXXXXXXXXXXXXX”, which is not illustrated in FIG. 13B, is made visually recognizable.

As described above, according to the third embodiment, even in a condition in which a display area that displays other information having a different priority is reduced, and all pieces of device information cannot be displayed in the display area, all pieces of device information can be made visually recognized in the display area by providing an input button that accepts an input of an instruction to enlarge/reduce display content, and a scroll bar that accepts an input of an instruction to switch an input content.

### 4 Fourth Embodiment

A fourth embodiment is an embodiment in which priority information can be set by a user.

### 4.1 Functional Configuration

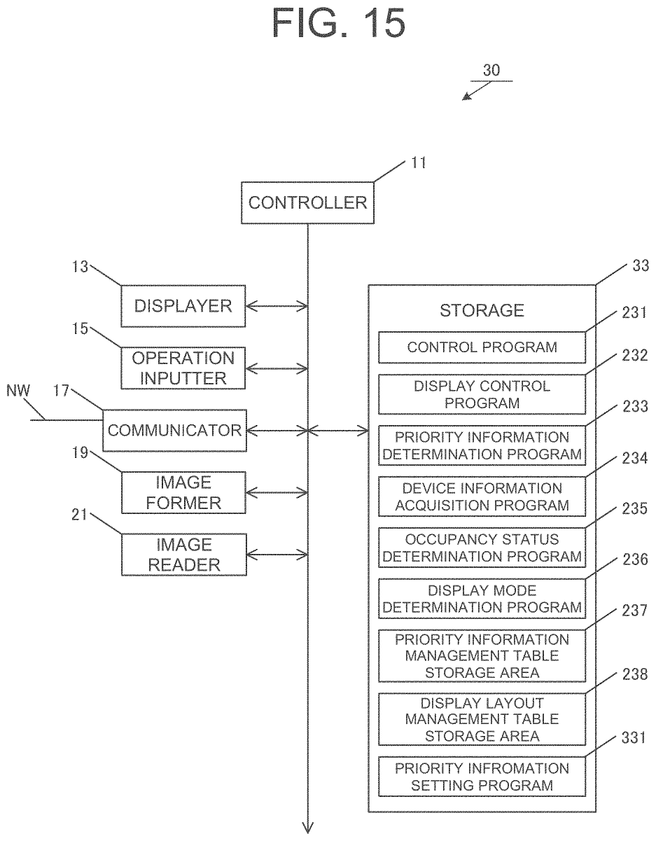

FIG. 15 is a functional configuration diagram illustrating a functional configuration of a multifunction machine 30 according to the fourth embodiment. The multifunction machine 30 includes a storage 33 in place of the storage 23 according to the first embodiment. Note that a component having a same configuration as that of the multifunction machine 10 is indicated with the same reference sign, and description thereof is omitted.

In the fourth embodiment, the storage 33 stores a control program 231, a display control program 232, a priority information determination program 233, a device information acquisition program 234, an occupancy status determination program 235, a display mode determination program 236, and a priority information setting program 331, and secures a priority information management table storage area 237 and a display layout management table storage area 238.

The priority information setting program 331 is a program to be read by a controller 11 when accepting an input to set priority information by the user. After reading the priority information setting program 331, the controller 11 displays a priority information setting screen on a displayer 13. The controller 11 stores, in the priority information management table, each setting value input via the priority information setting screen.

### 4.2 Flow of Processing

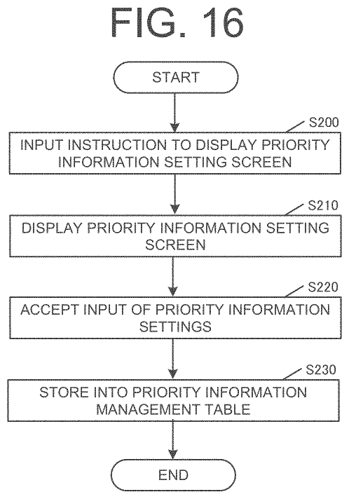

Processing of setting priority information via a priority information setting screen can be performed at any timing, such as before an instruction to display a system information screen as the information display screen illustrated in the flowchart of FIG. 5, FIG. 10, FIG. 12, or the like is input. Herein, priority information setting processing is described using the flowchart in FIG. 16.

The controller 11 accepts an input of an instruction to display a priority information setting screen by the user (step S200). In response to an input of an instruction to display a priority information setting screen, the controller 11 displays a priority information setting screen on the displayer 13 (step S210).

Next, the controller 11 accepts an input to set priority information by the user (step S220). In response to an input to set priority information, the controller 11 stores an input setting value in the priority information management table, and terminates the processing (step S230).

### 4.3 Operation Example

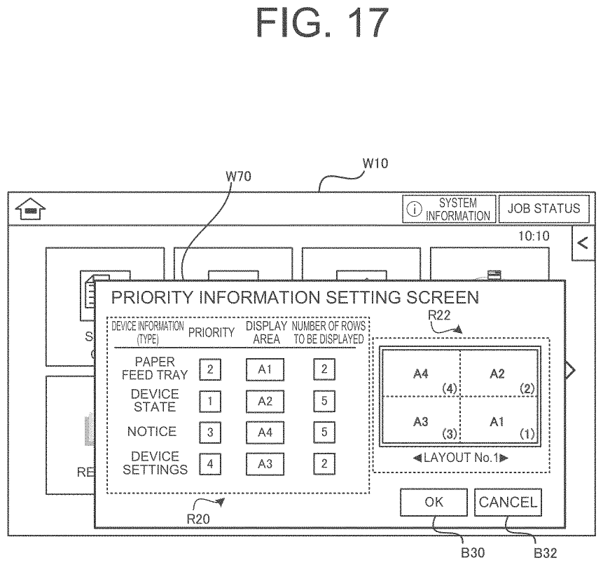

Next, an operation example according to the fourth embodiment is described. FIG. 17 is a diagram illustrating a configuration example of a priority information setting screen W70 to be displayed by the controller 11.

The priority information setting screen W70 includes a priority information setting area R20, a display layout pattern selection area R22, an OK button B30, and a cancel button B32.

The priority information setting area R20 is a selection area for setting a priority, a display area, and the number of display rows for a column display with respect to device information (type). Each setting item on the priority, the display area, and the number of display rows has an input box that accepts an input of each setting value.

For example, in the example in FIG. 17, a priority of device state information is set to “1”. The display area is “A2”, and “5” is set as the number of display rows.

The user can set priority information such as a priority by inputting a setting value for each setting item in the priority information setting area R20. Although an input button is illustrated as a setting value, for example, to facilitate an input of each setting value, a selectable setting value may be displayed in the form of pull-down display.

The display layout pattern selection area R22 is a selection area that accepts selection of a display position of each display area set in the priority information setting area R20. A display layout that indicates a display position of each display area is displayed in the display layout pattern selection area R22 in such a way that the display position of each display area can be specified. Note that, FIG. 17 is an example illustrating a display layout pattern of layout No. 1 illustrated in FIG. 4.

The OK button B30 is an input button that accepts determination regarding setting of priority information in the priority information setting area R20, and selection of a display layout in the display layout pattern selection area R22. The controller 11 stores these setting values and the like in the priority information management table by an input instruction accompanied by pressing of the OK button B30. The cancel button B32 is an input button that accepts an input of an instruction to cancel an operation via the priority information setting screen W70.

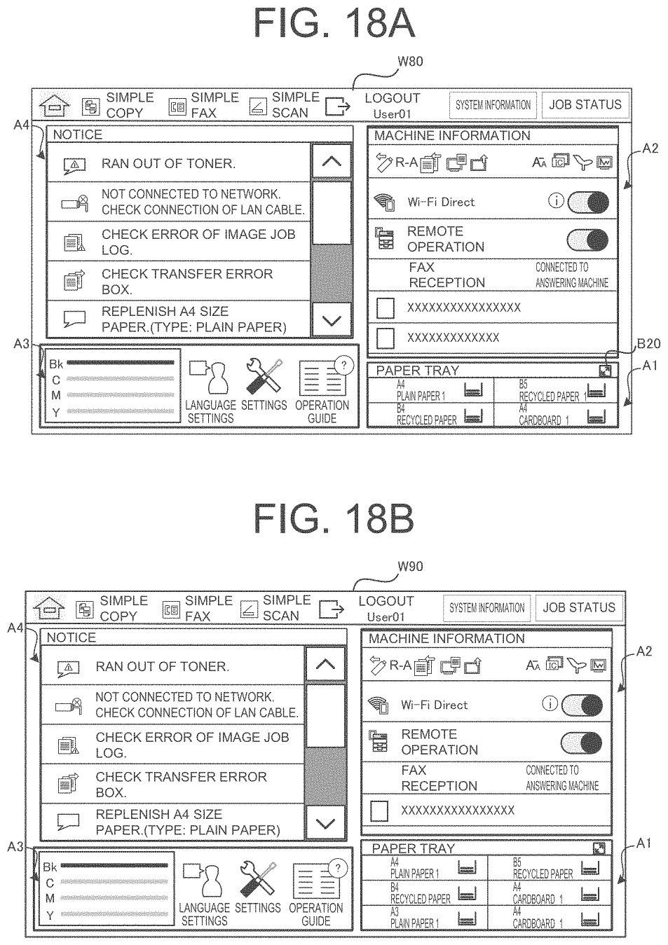

FIG. 18A is a configuration example of a system information display screen W80 reflecting priority information settings set via the priority information setting screen W70 in FIG. 17. In FIG. 17, device state information is set to have a highest priority, and “5” is set as the number of display rows. Therefore, in FIG. 18A, indication pertaining to an occupied area (A2) is prioritized, and paper feed tray information having a highest priority in the first embodiment and the like is set as other information.

Further, as well as FIG. 18A, FIG. 18B is an example in which device state information is set to have a highest priority, and “4” is set as the number of display rows. In this way, in the fourth embodiment, the user can change and set device information having a highest priority, the number of display rows, a display layout, and the like by user setting via the priority information setting screen W70.

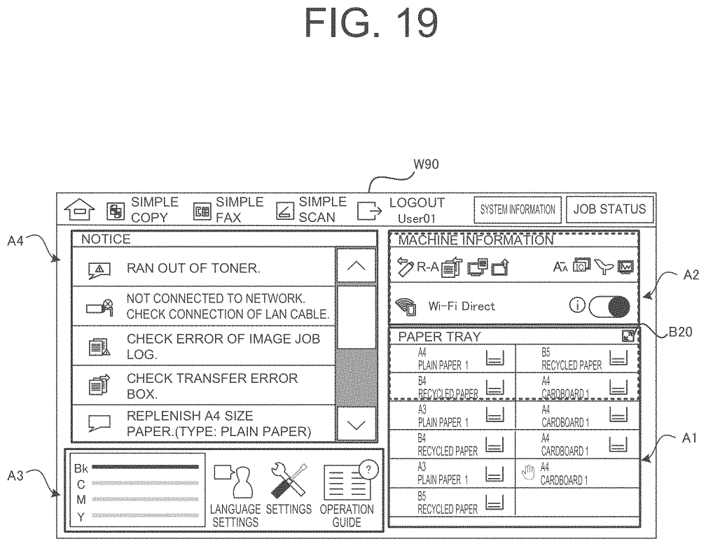

FIG. 19 is a diagram illustrating a configuration example of a system information display screen W90 to be displayed by the controller 11 in response to an input of an enlargement instruction by pressing of an input button B20, in a case where the input button B20 through which an enlargement/reduction instruction, which is described in the third embodiment, is input is provided in a display area (A1) of paper feed tray information set as other information having a different priority.

In response to an input of an enlargement instruction by the user, the controller 11 enlarges and displays the display area (A1). By enlarging and displaying the display area (A1) on the occupied area (A2) indicated by the dotted line frame in FIG. 18A in a superimposed manner, other information concerning a paper feed tray, which is an invisible display content in FIG. 18A or FIG. 18B is made visually recognizable.

As described above, according to the fourth embodiment, since priority information can be set by the user, other display area can be adjusted according to a change in a target display area, after individually securing a display area for displaying a plurality of items according to user settings.

The present disclosure is not limited to the above-described embodiments, and various changes are available. Specifically, embodiments to be acquired by appropriately combining modified technical means within a range that does not depart from the gist of the present disclosure are also included in the technical scope of the present disclosure.

Furthermore, some parts of the above-described embodiments are separately described for convenience of description but may be obviously implemented in combination within a technically allowable range.

In addition, a program operating in each device in the embodiments is a program (a program causing a computer to function) that controls a CPU or the like in such a way as to achieve functions of the above-described embodiments. Further, information to be handled by these devices is temporarily stored in a temporary storage device (e.g., a RAM) at the time of processing, and thereafter, is stored in a storage device such as various read only memories (ROMs), and HDDs, and is read and corrected/written by the CPU as necessary.

Herein, a recording medium for storing the program may be any of a semiconductor medium (e.g., a ROM, a non-volatile memory card, and the like), an optical recording medium/magneto-optical recording medium (e.g., a digital versatile disc (DVD), a magneto optical disc (MO), a mini disc (MD), a compact disc (CD), a Blu-ray (registered trademark) disc (BD), and the like), a magnetic recording medium (e.g., a magnetic tape, a flexible disk, and the like), and the like. In addition, not only functions of the above-described embodiments are achieved by executing a loaded program, but also functions of the present disclosure may be achieved by processing the program jointly with an operating system, other application program, or the like, based on an instruction of the program.

Further, in a case of distributing the program in the market, the program can be stored in a portable recording medium and distributed, or can be transferred to a server computer connected via a network such as the Internet. In this case, it is needless to say that a storage device of the server computer is also included in the present disclosure.

What is claimed is:

1. A display device comprising:
a displayer displaying pieces of information having different priorities for screen display in individual display areas; and
a controller that generates an information display screen by controlling screen display of the display areas, wherein
the controller determines, according to an occupancy status of a display area that displays information having the highest priority on the information display screen, a display mode of a display area that displays other information having different priority.

2. The display device according to claim 1, wherein
the controller enlarges or reduces a display area that displays the other information, based on the occupancy status.

3. The display device according to claim 1, wherein
the controller changes a display layout of a display area that displays the other information, based on the occupancy status.

4. The display device according to claim 1, wherein
the controller displays an input button that enlarges or reduces display content of the other information.

5. The display device according to claim 4, wherein
the controller displays a scroll bar that switches display content of the other information.

6. The display device according to claim 1, wherein
the controller displays a setting screen that accepts settings of the priority.

7. An image processing apparatus comprising:
the display device according to claim 1; and
an image processor.

8. The image processing apparatus according to claim 7, wherein
information having the highest priority is information on a recording medium to be supplied to the image processor.

9. The image processing apparatus according to claim 7, wherein
the other information having different priority is information on a device state.

10. A display method comprising:
displaying pieces of information having different priorities for screen display in individual display areas; and
generating an information display screen by controlling screen display of the display areas, wherein
the controlling includes determining, according to an occupancy status of a display area that displays information having the highest priority on the information display screen, a display mode of a display area that displays other information having different priority.
